(19) United States
(12) Patent Application Publication
(10) Pub. No.: US 2023/0189719 A1
(43) Pub. Date: Jun. 22, 2023

(54) VERTICAL GARDEN

(71) Applicant: Johannes Hendrik BREDENKAMP, Middelburg (ZA)

(72) Inventor: Johannes Hendrik BREDENKAMP, Middelburg (ZA)

(21) Appl. No.: 17/926,530

(22) PCT Filed: May 18, 2021
(86) PCT No.: PCT/IB2021/054248

§ 371 Date: Nov. 18, 2022

(30) Foreign Application Priority Data
May 18, 2020 (ZA) 2020/02865

(51) Int. Cl. A01G 9/02; A01G 27/02

(52) U.S. Cl. CPC A01G 9/023; A01G 27/02

(57) ABSTRACT

This invention relates to a vertical garden, and more particularly, but not exclusively, to modular containers for planting plants therein. The vertical garden has upper and lower containers and a connector for connecting the upper and lower container. The connector defines a flow path therein extending from an outlet opening of the upper container through a vertical irrigation and drainage conduit section to a transverse distribution conduit section with a number of outlet feeder holes in the distribution conduit section to distribute liquid into the lower container.

### FIELD OF THE INVENTION

This invention relates to a vertical garden, and more particularly, but not exclusively, to modular containers for planting plants therein.

### BACKGROUND TO THE INVENTION

Vertical modular gardens are well known and used.

U.S. Pat. No. US 7,516,574 B2 (“US ‘574”), entitled “Vertical garden” and filed in the name of John Gottlieb discloses a vertical garden that includes a reservoir containing a nutrient rich liquid. A stack of modular planters are nested together above the reservoir. A vertically extending tubular pipe passes through central openings in the modular planters. The tubular pipe communicates with a manifold within the reservoir. An air pump located outside of the reservoir has an outlet hose terminating in an air inlet port in the manifold. Compressed air flows from the air pump into the manifold and flows up through the pipe to a diffuser plate at the top. Compressed air rises in the vertically extending pipe entraining some of said liquid upward towards the top diffuser plate. Each modular planter has radiating planter ports for growing plants, wherein the planter ports contain plant media. Nutrient rich liquid trickles down from the diffuser plate, intersecting with and soaking the plant media in the planter ports.

US ‘574 does not disclose a wall mounted vertical garden. The vertical garden disclosed in US ‘574 also requires a power source to power the air pump. The air pump pumps nutrients from the reservoir (a pot) to the top of the pipe that hosts the planters.

European patent number EP 2 983 463 B1, entitled “Vertical garden system” and filed in the name of Shah, Kumarpal discloses a vertical gardening system in modular form. The vertical garden system is expandable horizontally as well as vertically. The vertical garden system of the present invention provides a drainage system wherein water is drained out at specific or regular distance intervals. The present invention further provides a vertical garden system wherein the water supply per pot can be regulated as per plant requirement. The vertical garden system of the present invention comprises a frame; drip irrigation pipe(s); drainage pipe(s); drain tray; and optionally pots or plant containers.

U.S. Pat. No. US 2011/0094153 AI, entitled “Vertical wall garden”, filed in the name of Humberto Urriola and assigned to Astral Property (Pty) Ltd discloses a vertical wall garden made from modular perforated plastics wall members, which form back walls, compartment walls and horizontal shelf members, whereby the back walls, compartment walls and horizontal shelf members, interlock with each other to form a layer of box like plant holding compartments with an open face. A first layer is positioned against a vertical wall with the open face facing outwardly from the wall, and additional layers are connected on top of each other until the required height of vertical wall garden is reached. The layers are then secured to the vertical wall. Plants are then placed in water permeable containers with soil and placed in the holding compartments with the plants facing outwardly from the wall. Watering means can be connected to wall garden to supply water to each plant. There is provided structural plastics support modules which are connected together to form a vertical wall garden which is fast to install, easy fixing on walls both indoors and outdoors, provides a friendly plant habitat and easy maintenance. Further the wall garden can support a large vertical load of plants and soil.

### OBJECT OF THE INVENTION

It is an object of this invention to provide a vertical garden of the type described above.

### SUMMARY OF THE INVENTION

In accordance with this invention there is provided a vertical garden, comprising upper and lower containers and a connector for connecting the upper and lower containers, the connector defining a flow path therein extending from an outlet opening of the upper container through a vertical irrigation and drainage conduit section to a transverse distribution conduit section with a number of outlet feeder holes in the distribution conduit section to distribute liquid into the lower container.

The connector has upper and lower connecting means to connect to the upper and lower containers.

The upper connecting means has an operatively outwardly and vertically extending flange, slideably connectable in receiving slots underneath the upper container.

The lower connecting means is a solid extension of the drainage and irrigation conduit with an outer screw thread, engageable in screw threaded bore at a bottom end of the lower container.

There is provided for the container to have a drainage device.

The drainage device is a plate with a plurality of holes therein to allow water to drain therethrough.

There is further provided for the drainage device to be spaced apart from a bottom wall of the container to form a collection cavity with the drainage device forming a roof of the collection cavity.

There is provided for the bottom wall of the container to be funnel shaped to direct water to a central collection area.

There is provided for a drainage opening to extend through the operatively lowest area of the bottom wall of the container.

There is also provided for the flow path defined by the irrigation and drainage conduit section be funnel shaped in cross section.

There is further provided for the liquid to be distributed by the distribution conduit and for the liquid to be water and/or a mixture of water and nutrients.

There is further provided for the container to have securing means to slideably secure it in a slot in a rail.

These and other features of the invention are described in more detail below.

### BRIEF DESCRIPTION OF THE DRAWINGS

One embodiment of the invention is described below, by way of example only, and with reference to the drawings in which:

FIG. 1 shows an exploded front-left exploded view of a vertical garden;

FIG. 2 shows a front-left view of the assembled vertical garden;

FIG. 3 shows a front-left view of the assembled vertical garden with a plurality of containers;

FIG. 4 shows a left-side view of the assembled connector and container;

FIG. 5 shows a front section view of the assembled connector and container;

FIG. 6 shows a front view of the assembled connector and container;

FIG. 7 shows a left-side section view of the assembled connector and container;

FIG. 8 shows an isometric font-top view of the assembled connector and container;

FIG. 9 shows an isometric left-top view of the assembled connector and container;

FIG. 10 shows an isometric top view of the container;

FIG. 11 shows a bottom isometric view of the container;

FIG. 12 shows an isometric front section view of the assembled vertical garden;

FIG. 13 shows a front section view of a flow path in assembled connectors and container; and

FIG. 14 shows a front section detailed view of connections connecting two connectors to a container.

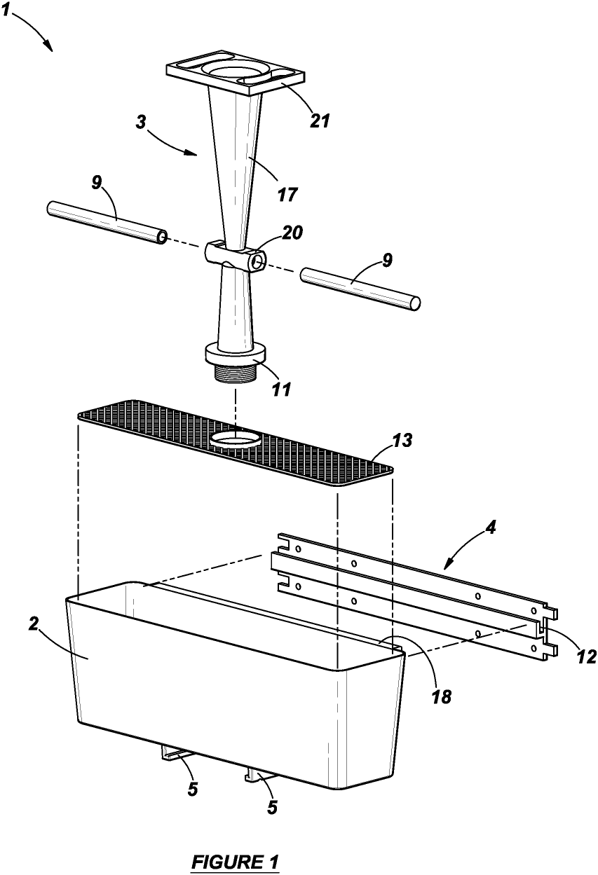

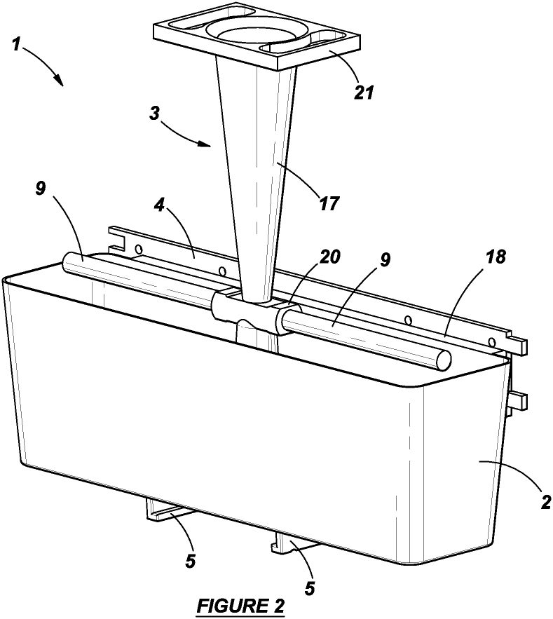

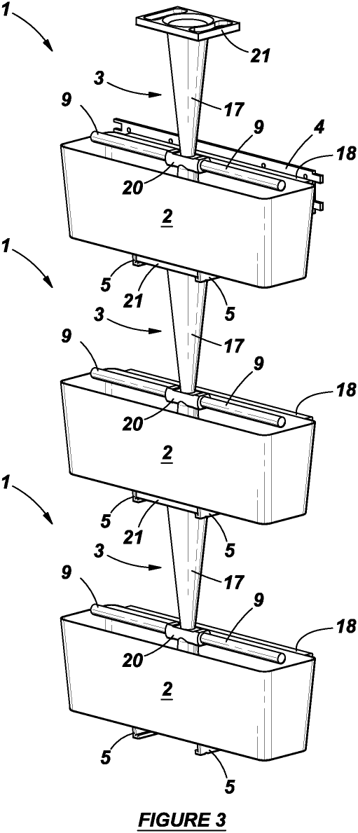

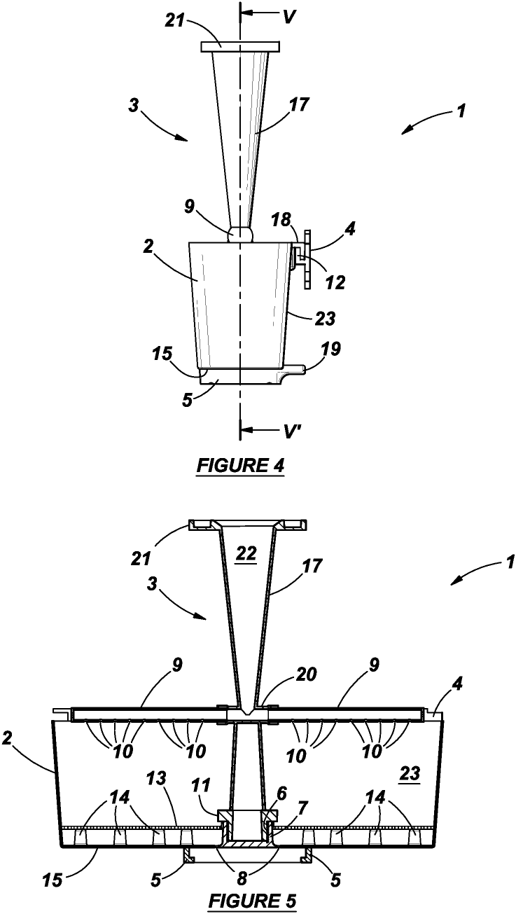

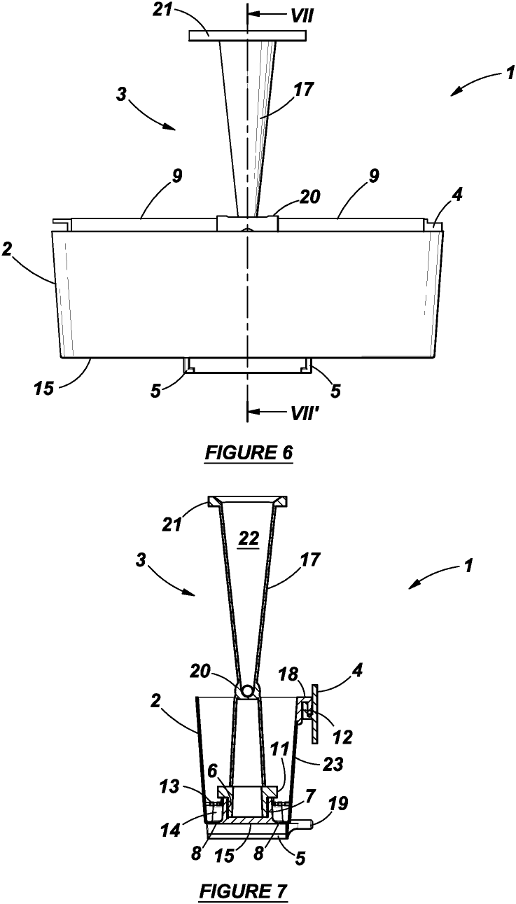

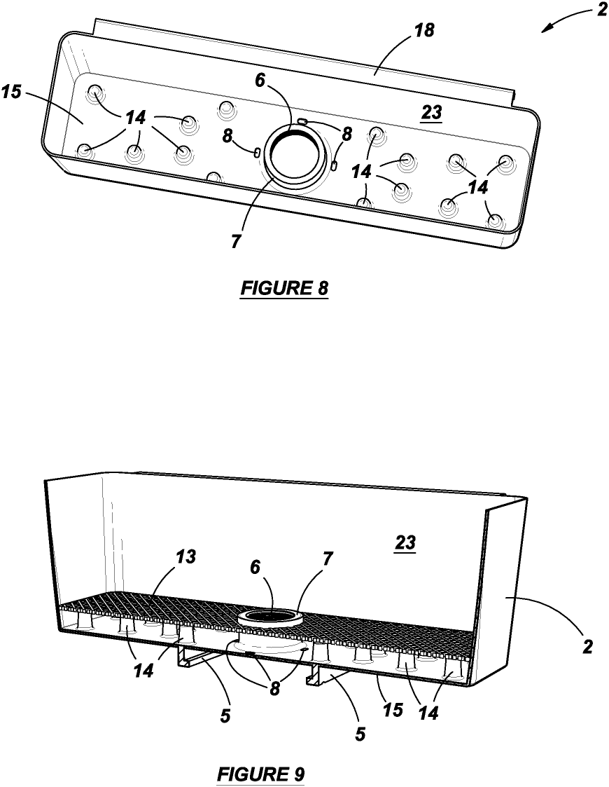

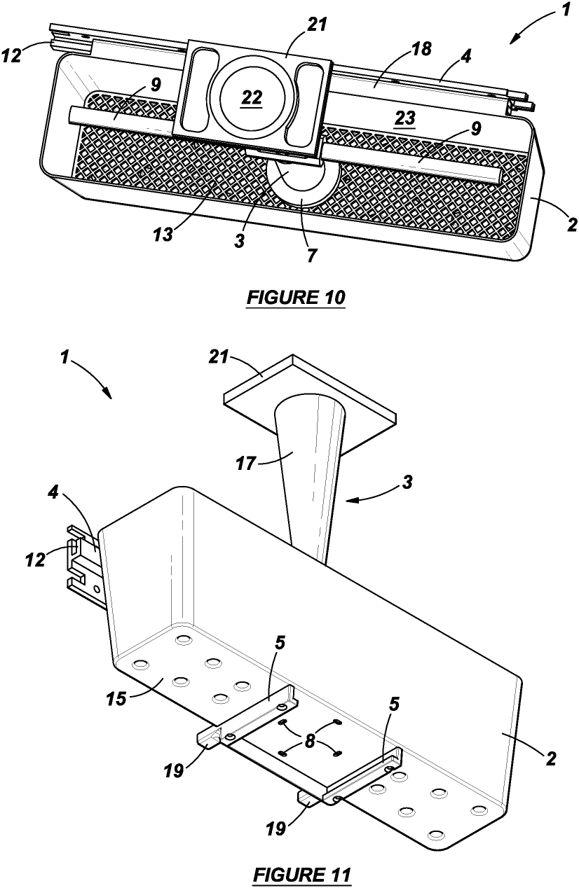

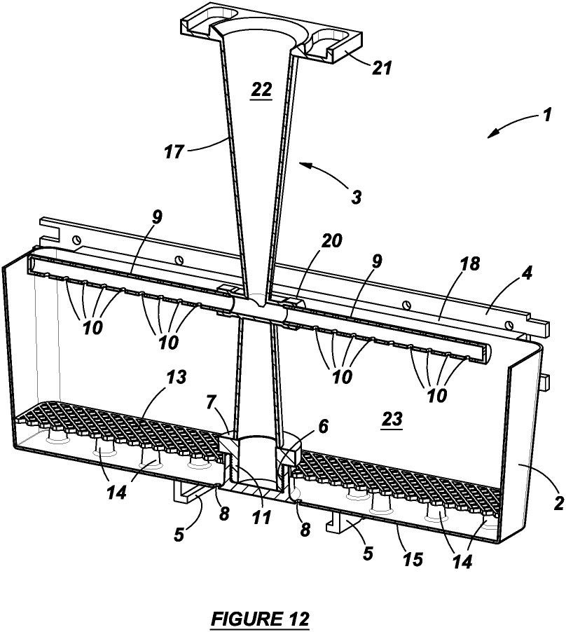

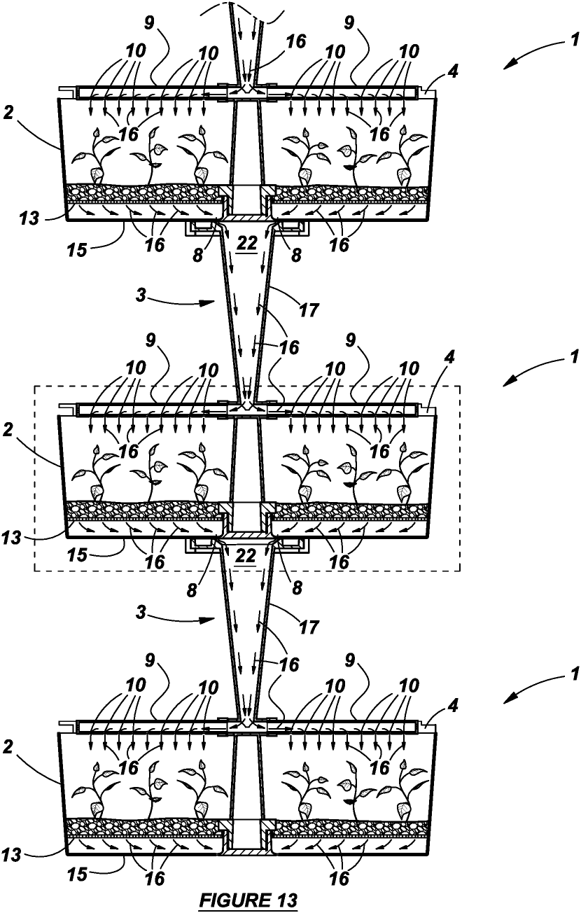

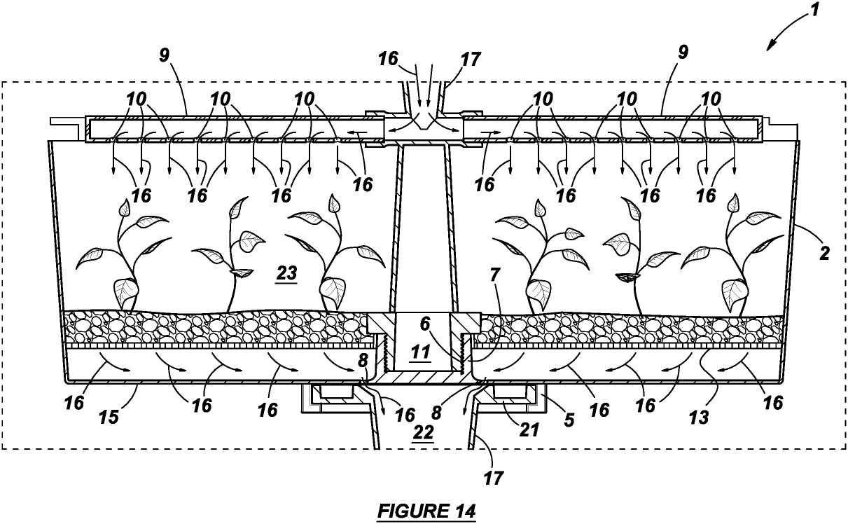

### DETAILED DESCRIPTION OF THE DRAWING

A vertical garden is indicated by reference numeral 1.

The vertical garden 1 has upper and lower containers 2 and a connector 3, for connecting the upper and lower containers 2.The connector 3 defines a flow path 16 therein extending from outlet openings 8 of the upper container 2 through a vertical irrigation and drainage conduit section 17 to a transverse distribution conduit section 9 with a number of outlet feeder holes 10 in the distribution conduit section 9 to distribute liquid, for example, water, into the lower container 2.

The connector 3 has upper and lower connecting means, irrigation and drainage conduit section 17 extending between the upper and lower connecting means and distribution conduit section 9 extending transversely from the irrigation and drainage conduit section 17. The upper and lower connecting means connect to the upper and lower containers 2.

The upper connecting means 21 has an operatively outwardly and vertically extending flange, slideably connectable in receiving slots 5 underneath the upper container 2. The flange extends around the outer top edge of the conduit section 17 and is square shaped in top view.

Conduit section 17 is shaped in the form of an hourglass. A funnel shaped cavity 22 extends into the conduit section 17. The top end of the funnel 22 is open ended. The funnel top opening extends over the outlet openings 8. A distribution conduit section connector 20 extends transversely away on opposing sides of the middle of the conduit section 17 and terminate in open ends.

Distribution conduit sections 9 locate in each open end of the connector 20. The distribution sections 9 are tubes with outlet feeder holes 10 therein to distribute water and/or nutrients into an associated container. The lower end of the funnel shaped flow path 22 of the conduit section 17 extends into the distribution tubes 9.

The lower end 11 of the connector 3 terminates in a solid cylindrical, coaxial extension. The extension 11 has an outer screw thread that engages with an inner screw thread 6 at an upper end of a short tube 7 to secure the connector 3 to a lower container 2.

The container 2 is rectangularly box shaped with an open top. Side walls of the container 2 incline towards a bottom wall 15. An inner surface of the bottom wall 15 of the container 2 is funnel shaped toward a centre of the bottom wall 15. The short tube 7 extends centrally from the bottom wall 15 at its lowest point. The short tube 7 extends upwards in the container and terminates in upper screw threaded, coaxial bore 6 into which the extension 11 of the connector is screws, as referred to above. The outlet openings 8 are spaced around the outer circumference of the tube 7 and extends through the bottom wall 15.

A number of spacer columns 14 extend normally upwardly from the bottom wall 15. A drainage device 13 in the form of a generally rectangular frame with a grid herein, rest on the spacer columns 14 to space it therefrom. An opening extends centrally through the drainage device 13 to correspond with the bore 6. A cavity is thus formed between bottom wall 15 and parts of side walls of the container 2 and the drainage device 13 that forms the roof of such cavity.

A rear wall 23 of the container 2 is concave to spaced most of its surface away from a wall against which it is installed.

The container 2 has securing means 18 on an outer surface of the rear wall 23. The securing means 18 is a hook formation. The hook formation 18 extends along the upper edge of the rear wall 23 of the container 2.

The hook formation 18 is slideably securable in a slot 12 in a rail 4. The rail 4 is secured against a wall to which the containers are installed.

A spacer formation 19 extends along the outer surface of a bottom end of the rear wall. The spacer 19 is a square extrusion and spaces the container 2 away from the wall.

In use, the connector connects upper and lower containers. The hook of an upper container is engaged in the slot of the rail and as many containers as required can be connected with connectors in line underneath the upper container to form a column of containers. In this manner a plurality of columns of containers may be suspended from a rail or rail sections. The flow path in the connectors allow for water that has drained from an upper container to be distributed into a lower container from where in may again be drained for distribution into yet a further lower container.

It is envisaged that the vertical garden described herein formed by the connectors and containers is easy to install in that only an upper container is secured to a rail or rail section which, in turn, is secured to a wall against which the vertical garden is to be installed. All lower containers are connected in line down the column and depend from the upper most container. Water can be added to only the upper container and will then automatically, under force of gravity, be distributed to all lower containers in the column of containers.

It will be appreciated by those skilled in the art that many other embodiments are possible without departing from the scope of the invention. For example, the drainage device may be made from a mesh material or alternatively, a sponge.

1. A vertical garden comprising upper and lower containers and a connector for connecting the upper and lower containers, the connector defining a flow path therein extending from an outlet opening of the upper container through a vertical irrigation and drainage conduit section to a transverse distribution conduit section with a number of outlet feeder holes in the distribution conduit section to distribute liquid into the lower container.

2. The vertical garden as claimed in claim 1 in which the connector has upper and lower connecting means to connect to the upper and lower containers.

3. The vertical garden as claimed in claim 2 in which the upper connecting means has an operatively outwardly and vertically extending flange, slideably connectable in receiving slots underneath the upper container.

4. The vertical garden as claimed in claim 2 in which the lower connecting means is a solid extension of the drainage and irrigation conduit with an outer screw thread, engageable in screw threaded bore at a bottom end of the lower container.

5. The vertical garden as claimed in claim 1 in which the container has a drainage device.

6. The vertical garden as claimed in claim 5 in which the drainage device is a plate with a plurality of holes therein to allow water to drain therethrough.

7. The vertical garden as claimed in claim 5 in which the drainage device is spaced apart from a bottom wall of the container to form a collection cavity with the drainage device forming a roof of the collection cavity.

8. The vertical garden as claimed in claim 7 in which the bottom wall of the container is funnel shaped to direct water to a central collection area.

9. The vertical garden as claimed in claim 7 in which a drainage opening extends through the operatively lowest area of the bottom wall of the container.

10. The vertical garden as claimed in claim 1 in which the flow path defined by the irrigation and drainage conduit section is funnel shaped in cross section.

11. The vertical garden as claimed in claim 1 in which the liquid is distributed by the distribution conduit.

12. The vertical garden as claimed in claim 1 in which the liquid is water.

13. The vertical garden as claimed in claim 1 in which the liquid is a mixture of water and nutrients.

14. The vertical garden as claimed in claim 1 in which the container has securing means to slideably secure it in a slot in a rail.

15. The vertical garden as claimed in claim 14 in which the container has securing means to slideably secure it in a slot in a rail.
